(19) United States
(12) Patent Application Publication
(10) Pub. No.: US 2013/0164153 A1
(43) Pub. Date: Jun. 27, 2013

(54) Fuel Pump Module Feed-Line Filter Hose

(71) Applicant: Continental Automotive Systems, Inc., Auburn Hills, MI (US)

(72) Inventors: Manjunath Pasupuleti Venkataramana, Auburn Hills, MI (US); Brandon John Goll, Orion, MI (US)

(73) Assignee: CONTINENTAL AUTOMOTIVE SYSTEMS, INC., Auburn Hills, MI (US)

(21) Appl. No.: 13/710,514

(22) Filed: Dec. 11, 2012

Related U.S. Application Data
(60) Provisional application No. 61/579,110, filed on Dec. 22, 2011.

(51) Int. Cl. F04B 53/20; B01D 29/00

(52) U.S. Cl. CPC F04B 53/20; B01D 29/0036
USPC 417/313; 210/416.4; 29/888.02

(57) ABSTRACT

A fuel pump module includes a fuel module flange covering and sealing an opening in a fuel tank of a vehicle. The flange has a top connector extending outside the fuel tank for delivering fuel to an engine, and a bottom connector extending inside the fuel tank and in fluid communication with the top connector. A filter hose includes a flexible tubular shell having first and second ends and an interior, and flexible filter structure disposed within the interior of the shell. The module includes a fuel pump. The first end of the shell is coupled to the bottom connector of the flange and the second end of the shell is coupled to an outlet of the fuel pump so that the filter structure filters fuel exiting the outlet of the pump so that filtered fuel can be delivered through the flange to the engine.

This application claims the benefit of U.S. Provisional Application No. 61/579,110, filed on Dec. 22, 2012.

### FIELD

This invention relates to fuel supply units for automobile vehicles and, more particularly, to a filter hose for a fuel pump module of a fuel supply unit.

### BACKGROUND

With reference to FIG. 1, a typical fuel supply unit for a vehicle is shown generally indicated at 10. The unit 10 includes a flange 12 configured to be sealed to a wall of a fuel tank 14. A flange tube 16 attaches to the top connector 17 of the flange 12 and extends outside of the tank 14. A delivery tube 18 is coupled to an end of the flange tube 16 so that the delivery tube 18 can deliver fuel to injectors of an engine (not shown). A feed-line hose 22 attaches to a bottom connector 20 of the flange 12 and to a separate filter 24. The bottom connector 20 fluidly communicates with the top connector 17 via port 21 there-between. A second feed line hose 30 is provided between the filter 24 and an inlet 26 of a fuel pump 28. The fuel pump 28 is typically provided in a reservoir 32. The reservoir 32, fuel pump 28, filter 24, feed hoses 22 and 30, and flange define a fuel pump module, generally indicated at 34.

The fuel pump module 34 performs the main functions of cleaning the fuel, transferring cleaned fuel from the fuel tank to the engine under pressure and indicates the amount of fuel remaining in the fuel tank 14. When fuel is filled in the tank 14, it has to be cleaned to remove the debris arising from within or external to the fuel system. This is presently performed by the use of a course filter (not shown) at the inlet of the fuel pump 28 and the fine filter 24 at the outlet 26 of the fuel pump 28. The filter 24 removes smaller particles exiting the fuel pump 28 and from external sources to eliminate the possibility of a blockage in the fuel injector/engine.

Thus, in the conventional fuel pump module 34, three components, the filter 24 and feed hoses 22 and 30 are required to filter the fuel that exits the fuel pump 28. There is a need to filter fuel exiting a fuel pump using fewer components to simplify manufacturing and assembly and to reduce cost and weight.

### SUMMARY

An objective of the invention is to fulfill the need referred to above. In accordance with the principles of an embodiment, this objective is achieved by a filter hose including a flexible tubular shell having first and second ends and an interior. The ends are constructed and arranged to be coupled between an outlet of a fuel pump and a fuel module flange that is constructed and arranged to deliver fuel to an engine of a vehicle. A flexible filter structure is disposed within the interior of the shell. When the shell is coupled between the fuel pump and the fuel pump module flange, the filter structure is constructed and arranged to filter fuel exiting the outlet of the fuel pump so that filtered fuel can be delivered through the fuel module flange and thus to the engine.

In accordance with another aspect of an embodiment, a fuel pump module for supplying fuel to a vehicle's engine is provided. The fuel pump module includes a fuel module flange constructed and arranged to cover and seal an opening in a fuel tank of the vehicle. The fuel module flange has a top connector extending outside the fuel tank for delivering fuel to an engine, and a bottom connector extending inside the fuel tank and in fluid communication with the top connector. A filter hose of the fuel pump module includes a flexible tubular shell having first and second ends and an interior, and flexible filter structure disposed within the interior of the shell. The fuel pump module includes a fuel pump. The first end of the shell is coupled to the bottom connector of the fuel module flange and the second end of the shell is coupled to an outlet of the fuel pump so that the filter structure filters fuel exiting the outlet of the pump so that filtered fuel can be delivered through the fuel module flange to the engine.

In accordance with yet another aspect of an embodiment, a method provides a fuel pump module for delivering fuel to an engine of a vehicle. The method provides a fuel pump in a fuel tank of a vehicle. A filter hose includes a flexible tubular shell having first and second ends and an interior and flexible filter structure disposed within the interior of the shell. The first end of the shell is coupled to a bottom connector of a fuel module flange, inside the fuel tank. The second end of the shell is coupled to an outlet of the fuel pump.

Other objectives, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification.

### BRIEF DESCRIPTION OF THE DRAWINGS

The invention will be better understood from the following detailed description of the preferred embodiments thereof, taken in conjunction with the accompanying drawings, wherein like reference numerals refer to like parts, in which:

FIG. 1 is a view of a conventional fuel pump module shown mounted inside a fuel tank and including a filter and a pair of feed-line hoses associated with the filter coupled between a flange and a fuel pump.

FIG. 2 is a view of a fuel pump module shown mounted inside a fuel tank and including a filter hose, in accordance with an embodiment, coupled between a flange and a fuel pump.

FIG. 3 is a side sectional view of a portion of the filter hose of FIG. 2.

FIG. 4 is a top sectional view of the filter hose of FIG. 2.

FIG. 5a is a view of the filter media walls of the filter hose of FIG. 2.

FIG. 5b is a view of another embodiment of the filter media walls that has two seams.

FIG. 5c is a view of another embodiment of the filter media walls that is cylindrical and has one seam.

### DETAILED DESCRIPTION OF AN EXEMPLARY EMBODIMENT

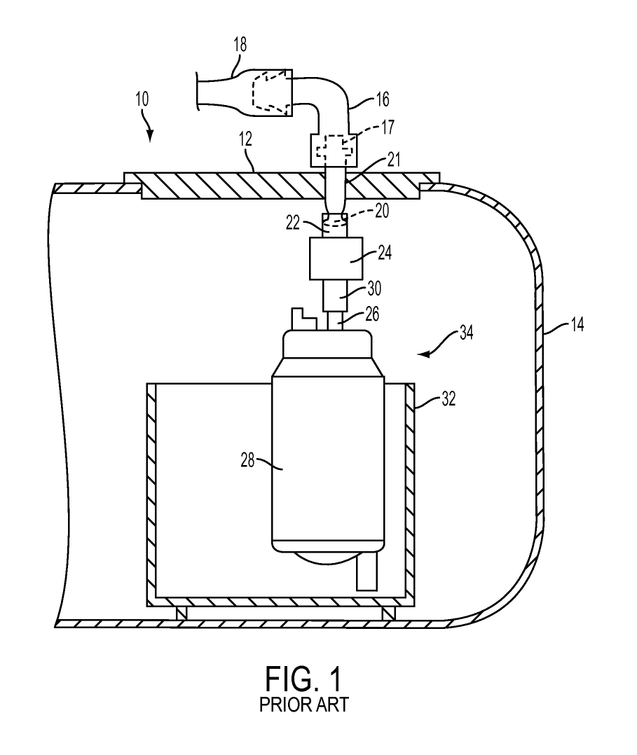

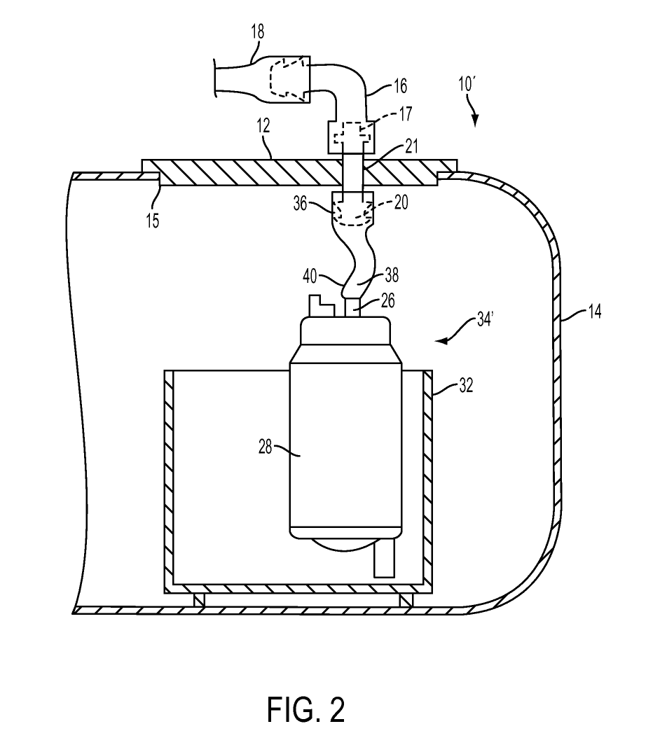

With reference to FIG. 2, a fuel supply unit for a vehicle in accordance with an embodiment is shown generally indicated at 10′. Similar to the unit 10 of FIG. 1, the unit 10′ includes a fuel module flange 12 configured to be sealed to a wall of a fuel tank 14 so as to cover an opening 15 in the tank 14. A flange tube 16 attaches to the top connector 17 of the flange 12 that is outside of the tank 14. A delivery tube 18 is coupled to an end of the flange tube 16 so that the delivery tube 18 can deliver fuel to injectors of an engine (not shown). An end 36 of a filter hose, generally indicated at 38, is coupled to bottom connector 20 of the flange 12 that extends into the fuel tank 14. The bottom connector 20 is preferably in the form of a barb-connection. Thus, the bottom connector 20 fluidly communicates with the top connector 17 via port 21 there-between. A second end 40 of the filter hose 38 is coupled to the outlet 26 of the fuel pump 28. The fuel pump 28 is typically provided in a reservoir 32. The reservoir 32, fuel pump 28, filter hose 38, and flange define a fuel pump module, generally indicated at 34′.

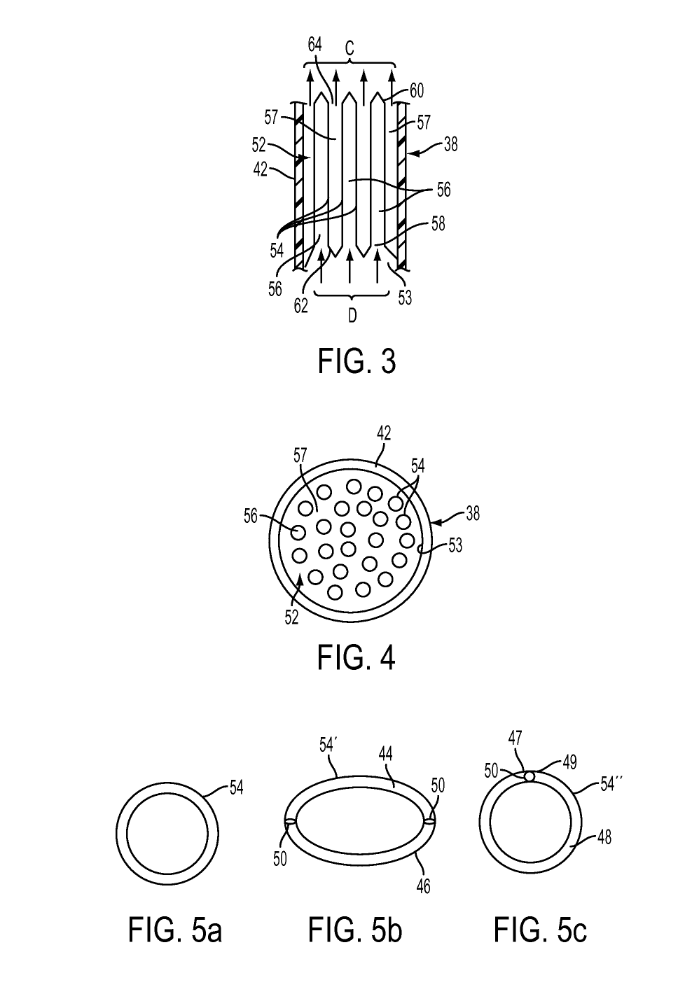

With reference to FIGS. 3 and 4, the filter hose 38 includes an outer tubular shell 42.

The tubular shell 42 is preferably made of nylon. In the embodiment, the outer diameter of the shell 42 is preferably about 2 cm and the shell 42 has a length preferably of about 40 cm.

As shown in FIGS. 3 and 4, flexible filter structure, generally indicated at 52, is provided in an interior 53 of the shell 42. The filter structure 52 is preferably manufactured in tubular form. FIG. 3 shows a side cross-sectional view of a portion of the filter hose 38. The filter structure 52 includes a plurality of filter media walls 54 defining a plurality of adjacent channels 56 and 57. Each channel 56 is open at a first end 58 thereof for receiving dirty fuel D from the fuel pump 28, and is closed at a second end 60. Each channel 57 is closed at a first end 62, adjacent a first end 58, and is open at a second end 64, adjacent to an end 60, so that the dirty fuel D is filtered as it passes through walls 54. The clean fuel C enters channels 57 so that the clean fuel C is delivered to the engine via tube 16. FIG. 4 shows a top view of the filter hose 38 with the walls 54 of the filter structure 52 being in the form of tubes. The walls 54 can instead be corrugated filter media of any flexible material suitable for filtering fuel. The number of walls 54, channels 57, 58, the length of the filter structure 52, and the diameter of the shell 42 can be selected to ensure that the filter structure 52 provides similar filter surface area as the conventional filter 24 of FIG. 1, which is typically about 800-1000 cm².

As shown in FIG. 5a, each of the filter media walls 54 can be a single piece extrusion or, as shown in FIG. 5b, each of the filter media walls 54 can be made of two parts 44, 46, or each of the filter media walls 54 of FIG. 5c can be made as one part 48 having ends 47, 49 that are joined together to define a cylindrical tube. The parts of FIGS. 5b and 5c can be joined at connections 50 by welding, brazing, adhesives or other joining techniques.

The filter hose 38 is preferably not a serviceable item so there is no need for removing or replacing the hose 38. The filter hose 38 reduces the number of components used in a fuel pump module thereby reducing cost, minimizes packaging, improves quality by reducing manufacturing complexities, and reduces the overall weight of the fuel pump module, which possibly increases gas mileage of a vehicle.

The foregoing preferred embodiments have been shown and described for the purposes of illustrating the structural and functional principles of the present invention, as well as illustrating the methods of employing the preferred embodiments and are subject to change without departing from such principles. Therefore, this invention includes all modifications encompassed within the scope of the following claims.

What is claimed is:

1. A filter hose comprising:
a flexible tubular shell having first and second ends and an interior, the ends being constructed and arranged to be coupled between an outlet of a fuel pump and a fuel module flange that is constructed and arranged to deliver fuel to an engine of a vehicle, and
flexible filter structure disposed within the interior of the shell,
wherein, when shell is coupled between the outlet of the fuel pump and the fuel module flange, the filter structure is constructed and arranged to filter fuel exiting the fuel pump so that filtered fuel can be delivered through the fuel module flange and thus to the engine.

2. The filter hose of claim 1, wherein the filter structure includes a plurality of filter media walls defining a plurality of adjacent first and second channels.

3. The filter hose of claim 2, wherein each first channel is open at a first end thereof for receiving fuel from the fuel pump, and each first channel is closed at a second end thereof, each second channel is closed at a first end thereof that is adjacent to a first end of a first channel, and each second channel is open at a second end that is adjacent to a second end of a first channel, so that the fuel from the fuel pump is filtered as it passes through the walls with the filtered fuel entering the second channels to be delivered to the engine via the fuel module flange.

4. The filter hose of claim 2, wherein the walls are in the form of tubes.

5. The filter hose of claim 2, wherein each of the filter media walls is a single piece extrusion.

6. The filter hose of claim 2, wherein each of the filter media walls comprises two separate parts that are joined together.

7. The filter hose of claim 2, wherein each of the filter media walls is a single part having two ends, the end being joined to define a generally cylindrical tube.

8. The filter of claim 1, wherein the shell is made of nylon.

9. A fuel pump module for supplying fuel to a vehicle's engine, the fuel pump module comprising:
a fuel module flange constructed and arranged to cover and seal an opening in a fuel tank of the vehicle, the fuel module flange having a top connector extending outside the fuel tank for delivering fuel to an engine, and a bottom connector extending inside the fuel tank and in fluid communication with the top connector,
a filter hose comprising:
a flexible tubular shell having first and second ends and an interior, and
flexible filter structure disposed within the interior of the shell, and a fuel pump,
wherein the first end of the shell is coupled to the bottom connector of the fuel module flange and the second end of the shell is coupled to an outlet of the fuel pump so that the filter structure filters fuel exiting the outlet of the pump so that filtered fuel can be delivered through the fuel module flange to the engine.

10. The module of claim 9, wherein the filter structure includes a plurality of filter media walls defining a plurality of adjacent first and second channels.

11. The module of claim 10, wherein each first channel is open at a first end thereof for receiving fuel from the fuel pump, and each first channel is closed at a second end thereof, each second channel is closed at a first end thereof that is adjacent to a first end of a first channel, and each second channel is open at a second end that is adjacent to a second end of a first channel, so that the fuel from the pump is filtered as it passes through the walls with the filtered fuel entering the second channels to be delivered to the engine via the fuel module flange.

12. The module of claim 10, wherein the walls are in the form of tubes.

13. The module hose of claim 10, wherein each of the filter media walls is a single piece extrusion.

14. The module of claim 10, wherein each of the filter media walls comprises two separate parts that are joined together.

15. The module of claim 10, wherein each of the filter media walls is a single part having two ends, the end being joined to define a generally cylindrical tube.

16. The module of claim 9, wherein the shell is made of nylon.

17. The module of claim 9, further comprising a reservoir, the pump being disposed in the reservoir.

18. A method of providing a fuel pump module for delivering fuel to an engine of a vehicle, the method comprising the steps of:
providing a fuel pump in a fuel tank of a vehicle,
providing a filter hose including a flexible tubular shell having first and second ends and an interior, and flexible filter structure disposed within the interior of the shell,
coupling the first end of the shell to a bottom connector of a fuel module flange, inside the tank, and
coupling the second end of the shell to an outlet of the fuel pump.

19. The method of claim 18, wherein the filter structure of the filter hose is provided as a plurality of filter media walls defining a plurality of adjacent first and second channels.

20. The method of claim 19, wherein each first channel is open at a first end thereof for receiving fuel from the fuel pump, and each first channel is closed at a second end thereof, each second channel is closed at a first end thereof that is adjacent to a first end of a first channel, and each second channel is open at a second end that is adjacent to a second end of a first channel, so that the fuel from the fuel pump is filtered as it passes through the walls with the filtered fuel entering the second channels to be delivered to the engine via the fuel module flange.
